(19) United States
(12) Patent Application Publication
(10) Pub. No.: US 2008/0040081 A1
(43) Pub. Date: Feb. 14, 2008

(54) SIMULATION METHOD FOR IMPROVING FREEDOM OF SETTING PARAMETERS RELATING TO INPUT/OUTPUT CHARACTERISTICS OF A MEMORY CHIP

(75) Inventors: Yoji NISHIO, Chuo-ku (JP); Seiji Funaba, Chuo-ku (JP); Yurika Aoki, Chuo-ku (JP); Kazuyoshi Shoji, Kodaira-shi (JP); Koji Matsuo, Kodaira-shi (JP); Mariko Otsuka, Kodaira-shi (JP); Ryuichi Ikematsu, Kodaira-shi (JP); Sadahiro Nonoyama, Kodaira-shi (JP); Kae Fujii, Kodaira-shi (JP)

Correspondence Address: SUGHRUE MION, PLLC, 2100 PENNSYLVANIA AVENUE, N.W., SUITE 800, WASHINGTON, DC, 20037, US

(73) Assignee: ELPIDA MEMORY, INC., Tokyo (JP)

(21) Appl. No.: 11/676,183

(22) Filed: Feb. 16, 2007

(30) Foreign Application Priority Data
Feb. 17, 2006 (JP) 2006-041009

(51) Int. Cl. G06F 17/50

(52) U.S. Cl. 703/1

(57) ABSTRACT

In the simulation method of the present invention; one parameter is first selected from a plurality of parameters that relate to input/output characteristics. Next, regarding setting lines provided in a file for setting necessary choices from among a plurality of choices for a selected parameter, it is determined to either set choices by means of comment symbols that cause non-execution of the relevant lines, or set choices by means of identification codes, which are identifiers common to chips in which the same choice are to be set. When choices are to be set by means of comment symbols, the comment symbols of the setting lines of the necessary choices among the plurality of choices are deleted to make these setting lines effective. Alternatively, when choices are to be set by means of identification codes, the identification codes included in setting lines are rewritten to information for setting to the necessary choices. Finally, the simulation is executed.

This application is based upon and claims the benefit of priority from Japanese Patent Application No. 2006-41009 filed on Feb. 17, 2006, the content of which is incorporated by reference.

### BACKGROUND OF THE INVENTION

1. Field of the Invention:

The present invention relates to a simulation method relating to input/output characteristics of a memory chip and to a program for causing a computer to execute this method.

2. Description of the Related Art:

International standards have been established for an IBIS (Input/Output Buffer Information Specification) model that models the electrical characteristics and input/output characteristics of an integrated circuit package (EIA-656-A). IBIS is a standard model of a silicon transmission line simulator in the electrical characteristics standards of I/O buffers established by the American National Standards Institute (ANSI)/Electronic industries Association (refer to JP-A-2003-141205).

In the field of DRAM (Dynamic Random Access Memory), which is one type of integrated circuit, memory having the ODT (On-Die Termination) function, memory having a driver strength adjustment function, and memory modules that package these memories are being commercialized.

A memory with the ODT function is memory having termination resistance elements in input circuit units of data input/output terminals, DDR2 SDRAM (Double Data Rate-2 Synchronous DRAM) being a representative example. This function can prevent the reflection of input signals. In the following explanation, the resistance value of such a termination resistance element is referred to as the “ODT value.”

A memory having the driver strength adjustment function is memory that allows adjustment of the size of the output transistor of the output circuit unit of a data input/output terminal. A DDR2 SDRAM is a representative example. This function allows selection of an output circuit that is suitable to the load of an outside unit.

Explanation next regards simulation relating to the input/output characteristics according to IBIS description for the case of a DIMM (Dual Inline Memory Module). As a parameter in the following explanation, the choices of ODT values are assumed to he: OFF. 50Ω. 75Ω. and 150Ω. In addition, the choices of driver strength as parameter are: full power, one-half of full power, one-fourth of full power, and one-eighth of full power.

FIG. 1 is an outside perspective view giving a schematic representation of a DIMM. As shown in FIG. 1, in DIMM 100, stacked DRAM 102 are provided as stacked chips on the nine sites from UM00 to UM08 on the front side of package substrate 101 and the nine sites from UM09 to UM17 on the back side. In each of stacked DRAM 102 shown in FIG. 1, two chips are stacked and mounted in stacked package (PKG). In the following explanation, of stacked DRAM 102 at sites UMxx, the lower chips, which are closer to package substrate 101, are indicated as “UMxxLower,” and upper chips, which are mounted on the lower chips, are indicated as “UMxxUpper.”

FIG. 2 is a schematic view showing an example of the settings of ODT values of a DIMM. FIG. 2 shows an example provided with two of the DIMMs shown in FIG. 1.

As shown in FIG. 2, the two DIMMs 105 and 106 of Slot 1 and Slot 2 and controller 107 for controlling these two DIMMs are mounted on mother board 108. All ODT values are set to OFF at sites UM00 and UM09 of DIMM 105 of Slot 1. As for the ODT values of site UM00 in DIMM 106 of Slot 2, the lower chips are set to OFF and the upper chips are set to 150Ω. For the ODT values of site UM09, the lower chip is set to OFF and the upper chip is set to 75Ω.

The simulation of the IBIS description is then carried out with ODT values set for each of the chips mounted in the DIMM as described above.

The following simple explanation next regards a simulation model of the prior art of stacked chips that are provided in a DIMM. FIG. 3 is an example of a circuit block diagram for explaining the stacked chip simulation model. As shown in FIG. 3, IBIS description is defined with one package 500 and one chip (LSI chip) 502 for one external terminal 504. LSI chip 502 has output circuit 506 and clamp circuit 508. In this way, stacked chips having a plurality of chips are modeled as one input/output.

In a model of IBIS description of the prior art, the parameters such as ODT value and driver strength and the value of each parameter are set in advance in a program, and after setting, the program is offered to users. In this case, parameters such as ODT values could not be selected later on the user side. Than, when modeling a memory module in which memory provided with the ODT function or memory provided with the driver strength adjustment function are packaged, the provider of the model was required to prepare a model file for each parameter.

In a manufactured DDR2, if UM00 and UM09 of the DIMM shown in FIG. 1 are taken as one pair, four choices for the ODT values in this portion can be considered for each of the total of four chips of the upper and lower chips of UM00 and the upper arid lower chips of UM09. This results in a total of 4×4×4×4=258 combinations of ODT values. Since there are the nine pairs (UM00, UM09), (UM01, UM10), . . . , (UM08, UM17) on the DIMM, the number of combinations of ODT values is vast. There are as many models as there are ODT values that can be selected for each UM, and to deal with the demands of users, the number of models that must be prepared is enormous. The same situation is true for the settings for driver strength. As a result the problems exist that considerable labor is demanded of the provider of the models, while users are faced with the difficulty of choosing from among many files, or the frustration of finding that a model having the desired combination of ODT is not offered.

As shown in FIG. 3, IBIS descriptions of stacked chips are defined as one input/output for one external terminal. However, as shown in the schematic sectional view of stacked chips in FIG. 4, the wiring distances are different for wiring from external terminal 123 to each of upper chip 121 and lower chip 122.

FIGS. 5A to 5C are signal route charts giving a schematic representation of the flow of signals In the stacked chips shown in FIG. 4. As shown in FIGS. 5B and 5C, the paths of signals particular to a chip are different for each chip. In addition, as shown in FIG. 5A, the paths of signals such as data input/output and clocks differ for each chip. Thus, the problem exists that, in stacked chips in which the wiring length differs between upper and lower chips, signal paths between one external terminal and a plurality of chips cannot be expressed with high accuracy in the IBIS description of the prior art.

### SUMMARY OF THE INVENTION

It is an object of the present invention to provide a simulation method in which, for memory having a plurality of chips, parameters relating to input/output characteristics can be set by users, and to a program for causing a computer to execute this method.

According to the present invention, a simulation method for performing, on an information processor, simulation of an IBIS description relating to the input/output characteristics of a memory module that includes a plurality of chips, comprises: a parameter selection step for selecting one from a plurality of parameters relating to the input/output characteristics; a setting method determination step for, regarding setting lines provided in a file for setting necessary choices from among a plurality of choices for a selected parameter, determining whether to set the choices by means of comment symbols described at the heads of lines for causing non-execution of the lines, or to set the choices by means of identification codes, which are identifiers common to chips that are to be set to a same choice; a choice setting step for, when choices are to be set by means of the comment symbols in the setting method determination step, deleting the comment symbols of the setting lines of the necessary choices among the plurality of choices to make these setting lines effective; and when choices are to be set by means of the identification codes in the setting method determination step, rewriting the identification codes contained in the setting lines to information for setting the necessary choices; and a step for executing simulation after the choice setting step.

According to the present invention, a simulation method for performing, on an information processor, simulation of an IBIS description relating to the input/output characteristics of a stacked package in which a plurality of chips are stacked, comprises: a modeling step of modeling wiring that is connected from a terminal for connecting to the outside to each chip of the plurality of chips by EBD; and a step of executing simulation after the modeling step.

According to the present invention, a recording medium in which a program is recorded that can he read by a computer that executes simulation of IBIS description relating to input/output characteristics of a memory module, the program causing the computer to execute processing, includes the steps of: upon input of instructions to select one from a plurality of parameters relating to the input/output characteristics, determining a parameter by means of the instructions; regarding setting lines provided in a file for setting necessary choices from among the plurality of choices of a determined parameter, when instructions are received as input that indicate the setting of choices by means of comment symbols described at the heads of lines for causing the non-execution of the lines, and instructions are received as input for deleting the comment symbols of setting lines of the necessary choices among the plurality of choices, deleting the comment symbols of the setting lines to make those lines effective; or, when instructions are received as input indicating the setting of choices by means of identification codes, which are identifiers common to chips that are to be set to a same choice, and information is received as input for setting the identification codes contained in the setting lines to the necessary choices, rewriting the identification codes contained in the setting lines to information for setting the necessary choices, and after the necessary choices have been set and upon receiving instructions indicating that simulation is to be executed, executing the simulation.

According to the present invention, a recording medium in which a program is recorded that can be read by a computer that executes simulation of IBIS description relating to input/output characteristics of a stacked package in which a plurality of chips are stacked, the program causing the computer to execute processing, includes the steps of: upon receiving description by EBD regarding wiring from a terminal for connection to the outside to each chip of the plurality of chips, modeling the wiring by EBD; and after modeling the wiring by EBD and upon receiving instructions as input indicating that simulation is to be executed, executing the simulation.

The simulation method of the present invention facilitates the settings of parameters and choices of these parameters relating to the input/output characteristics of a plurality of memory chips and eliminates the need to prepare simulation models according to the plurality of choices for each memory chip, as in the prior art.

According to another simulation method of the present invention, simulation can be carried out relating to the input/output characteristics according to the distance from an external terminal to each chip for a plurality of stacked chips.

Accordingly, the present invention reduces the labor imposed on a provider of simulation models relating to the input/output characteristics of a semiconductor device having a plurality of memory chips and facilitates the use of the simulation models by users. The present invention further enables the execution of highly accurate simulation.

The above and other objects, features and advantages of the present invention will become apparent from the following description with reference to the accompanying drawings which illustrate examples of the present invention.

### BRIEF DESCRIPTION OF THE DRAWINGS

FIG. 1 is an external perspective view giving a schematic representation of a DIMM;

FIG. 2 is a schematic view of an example of the ODT settings of the DIMM shown in FIG. 1;

FIG. 3 is an example of a circuit block diagram for explaining a simulation model of stacked chips;

FIG. 4 is a schematic sectional view of stacked chips;

FIGS. 5A to 5C are schematic views showing the signal paths of the stacked chips shown in FIG. 4;

FIG. 6 is a block diagram showing an example of the configuration of an information processor for carrying out simulation of the present embodiment;

FIGS. 7A and 7B are views for explaining the simulation modal of the first working example;

FIG. 8 is a flow chart showing the procedure of the simulation method of the first working example;

FIGS. 9A and 9B are views for explaining the simulation method of the second working example:

FIG. 10 is a view for explaining the simulation method of the third working example;

FIG. 11 is a schematic view showing an example of the settings of ODT values of a DIMM in the fourth working example;

FIG. 12 is a view for explaining the simulation method of the fourth working example;

FIG. 13 is a view for explaining the simulation method of the fifth working example; and

FIG. 14 is a flow chart showing the procedure of the simulation method of the eighth working example.

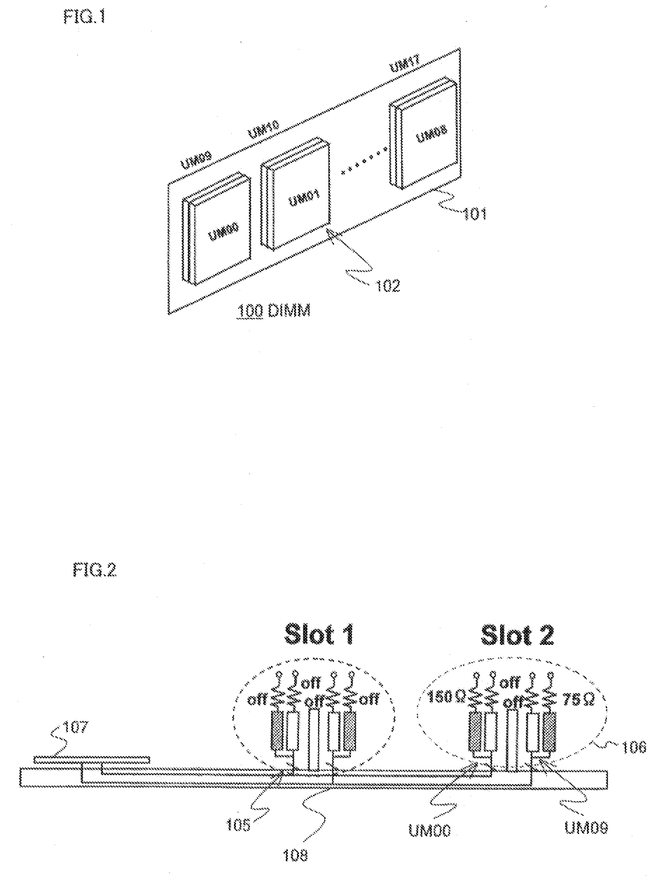

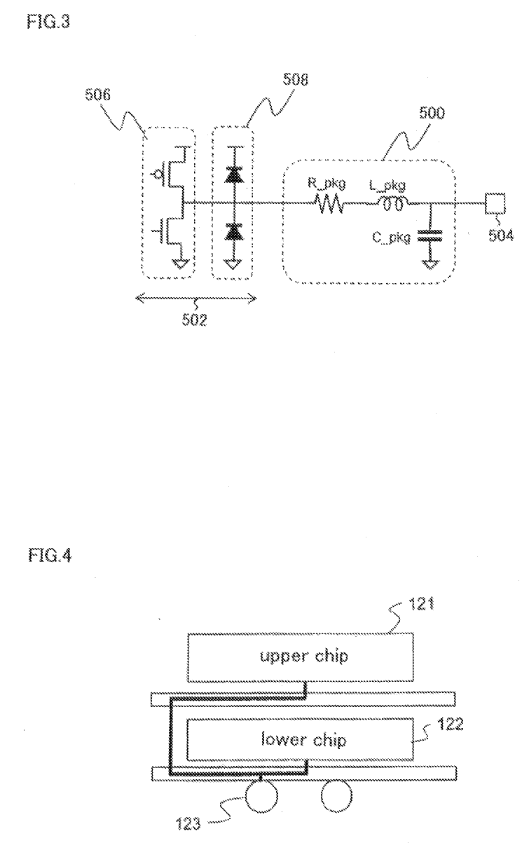

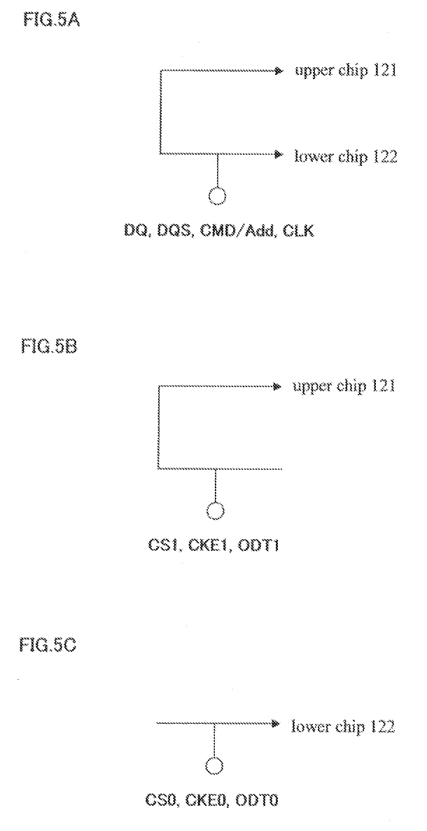

### DETAILED DESCRIPTION OF THE PREFERRED EMBODIMENTS

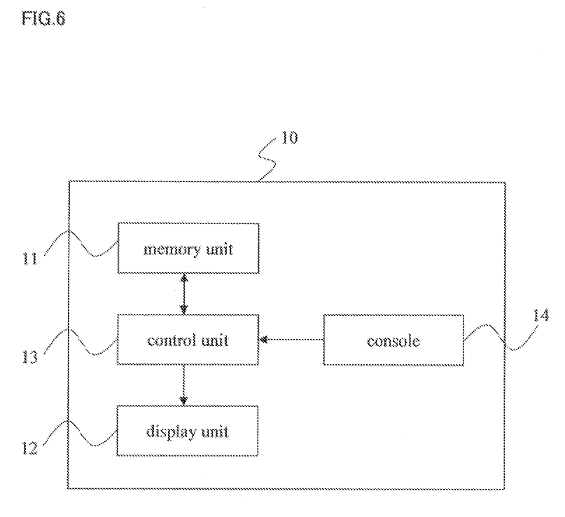

Explanation first regards the configuration of an information processor for carrying out the simulation method of the present embodiment. FIG. 6 is a block diagram showing an example of the configuration of an information processor.

As shown in FIG. 6, information processor 10 is a computer such as a personal computer or work station and is of a configuration that includes: memory unit 11, display unit 12, control unit 13 for carrying out simulation processing, and moreover, for controlling each unit; and console 14 for the input of instructions by a user. Memory unit 11 is provided with a hard disk (HD) and a temporary save area such as RAM. The application program for simulation (hereinbelow referred to as simply the “program”) is stored in the HD in advance. In addition, files for settings of parameters relating to input/output characteristics are stored in the HD in advance. These files are read from the HD when the program is executed. Display unit 12 displays the description content of the program and the results of simulation. Control unit 13 includes a CPU (Central Processing Unit) for executing prescribed processes in accordance with a program and a memory for storing a program. Console 14 is an input device such as a keyboard or a mouse.

When the user manipulates console 14 and enters instructions to call out a file for parameter settings, control unit 13 copies a file stored in the HD of memory unit 11 to the temporary save area to enable rewriting of the file, and this description is displayed on display unit 12. When the user next manipulates console 14 and uses a text editor that is typically provided as a text editing function to edit the file in accordance with a desired model, control unit 13 updates the file stored in the temporary save area in accordance with the input instructions. When the user enters a command to execute simulation after the above-described setting, control unit 13 reads the program that is stored in HD and the file that is stored in the temporary save area, and executes processing in accordance with the program description. The simulation results are then displayed on display unit 12.

Explanation next regards a working example of the simulation method of the present invention using this information processor. In the following explanation, the memory is assumed to be DRAM.

### FIRST WORKING EXAMPLE

The present working example is a simulation method of a stacked PKG.

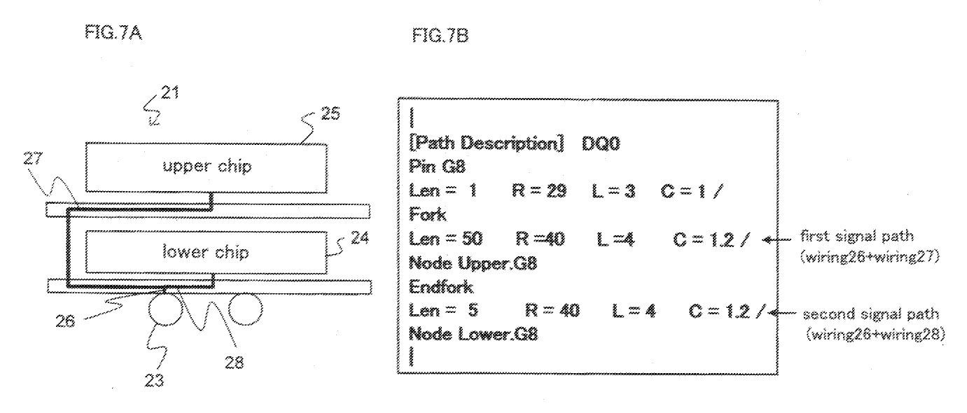

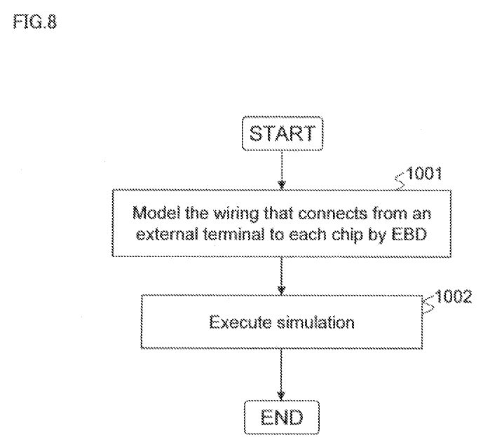

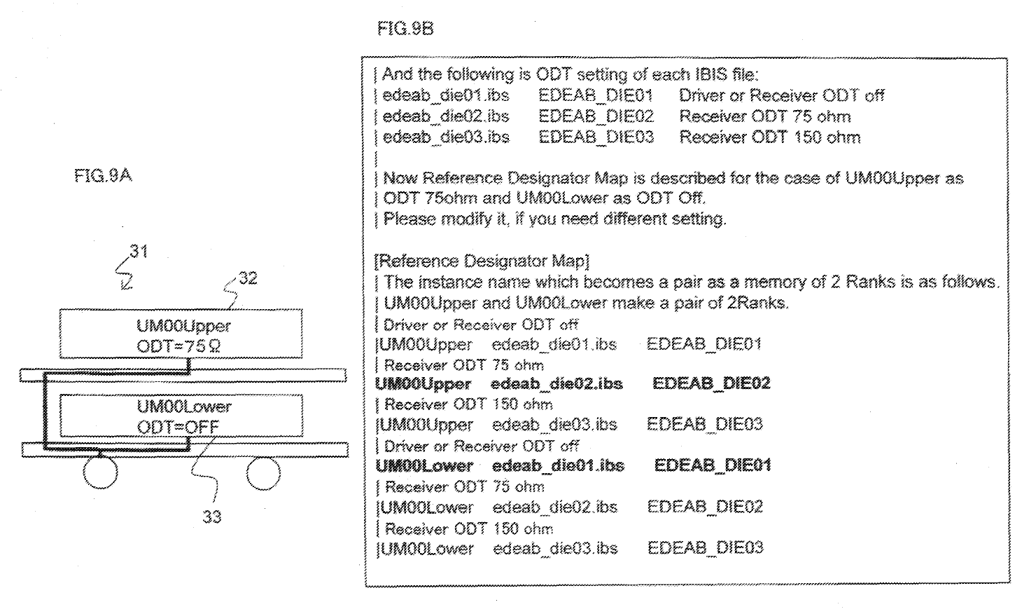

FIGS. 7A and 7B are views for explaining a simulation model of the present working example. FIG. 7A is a schematic view showing an example of the configuration of a stacked PKG. As shown in FIG. 7A, stacked DRAM 21 is of a configuration in which two memory chips are stacked. Of the two memory chips, the memory chip closer to external terminal 23 is lower chip 24, and the other memory chip is upper chip 25. Wiring 26 extending to the two chips from external terminal 23 splits midway into two, wiring 27 being connected to upper chip 25 and wiring 28 being connected to lower chip 24. First signal path that arrives at upper chip 25 from external terminal 23 by way of wiring 26 and wiring 27 is longer than second signal path that arrives at lower chip 24 from external terminal 23 by way of wiring 26 and wiring 28.

FIG. 7B is an example of the description expressing the signal path between the external terminal and upper and lower chips in the configuration of the stacked PKG shown in FIG. 7A, this description being expressed as EBD (Electrical Board Description). EBD expresses by a standard format the characteristics of substrate-level components in IBIS standards. EBD is standardized by IBIS Ver. 3.0. EBD is used in the IBIS description of a memory module in which a plurality of chips is packaged and takes into consideration the wiring length from an external terminal to each chip. As shown in FIG. 7B, the first signal path from external terminal 23 to one chip and the second signal path from external terminal 23 to the other chip are expressed in the description of “Path Description.”

Explanation next regards the simulation method of the present working example. FIG. 8 is a flow chart showing the procedure of the simulation method of the present working example. The wiring from the external terminal that connects to each chip is modeled by EBD (Step 1001). The simulation is then executed (Step 1002).

In the present working example, the simulation model relating to the input/output characteristics of stacked DRAM is in EBD description. As a result, for a stacked PKG having a plurality of chips connected to one external terminal, it is possible to carry out a simulation relating to the input/output characteristics that correspond to the distance from the external terminal to each chip, and the signal path between the external terminal and each chip can be modeled with higher accuracy. In addition, this simulation model may be described in a program in advance, files for settings may be prepared in advance, and files may be edited and updated.

### SECOND WORKING EXAMPLE

This working example is a simulation method of a memory module. The case of a 2-Rank-DRAM module is here considered in which a plurality of chips is grouped in Ranks, which are the units for a single access when accessing the outside, there being “2” of these Ranks.

FIGS. 9A and 9B are views for explaining the simulation model of the present working example. FIG. 9A is a schematic view showing an example of the configuration of a 2-Rank-DRAM module. As shown in FIG. 9A, stacked DRAM 31 positioned at UM00 of the module has upper chip 32 and lower chip 33. In upper chip 32, ODT is set to 75Ω, and ODT is set to OFF in lower chip 33.

FIG. 9B is an example of a file for setting parameters relating to the input/output characteristics of the stacked DRAM unit shown in FIG. 9A. The figure shows an example of the “Reference Designator Map” entry in the EBD description.

To enable setting of any one of OFF, 75Ω, and 150Ω as the choices for ODT value for each chip, IBIS choice file name (***.ibs) and component name (EDEAB-DIE*), which are the identifiers of these choices, are defined in advance. These are items of information for setting desired choices in the lines.

ODT=OFF: edeab_die01. ibs EDEAB_DIE01

ODT=75Ω: edeab_die02.ibs EDEAB_DIE02

ODT=150Ω: edeab_die03.ibs EDEAB_DIE03

The lines for setting are then described corresponding to the above-described three choices for upper chip 32 and lower chip 33 of UM00 in the “Reference Designator Map” entry of FIG. 9B. For example, the line for setting the ODT of upper chip 32 of UM00 to OFF is: “|UM00Upper edeab_die01.ibs EDEAB_DIE01”. At the head of the line, the comment symbol “|” for preventing the line from being executed is appended in advance.

In the description shown in FIG. 9b, the line for setting the ODT of upper chip 32 to 75Ω is: “UM00Upper edeab_die02.ibs . . . ”, and the comment symbol “|” is not appended to the head of the line. The line for setting the ODT value to 75Ω is thus effective. The line for setting the ODT of lower chip 33 to OFF is: “UM00Lower edeab_die01.ibs . . . ” and the comment symbol “|” is not appended at the head of the line. In this case, the line for setting the ODT value to OFF is effective. In this way, lines become effective when the simulation is executed by deleting the comment symbols of the lines for setting the ODT values.

In the present working example, the setting of ODT of each chip is carried out by deleting the comment symbol “|” at the head a setting line that is to be selected from a plurality of choices in the “Reference Designator Map” entry. The user deletes the comment symbols of setting lines in accordance with the ODT settings that are necessary for each chip and thus makes effective those choices that were set during use and enables the desired simulation. The present working example allows the freedom to realize all ODT combinations.

### THIRD WORKING EXAMPLE

Although the user uses a text editor to directly edit files in the second working example, the present working example is a case in which the user sets choices for parameters on a dedicated setting screen. Hereinafter, lines for setting the choices of ODT values in which comment symbols “|” are appended at the heads of the lines, are referred to as “choice setting lines”.

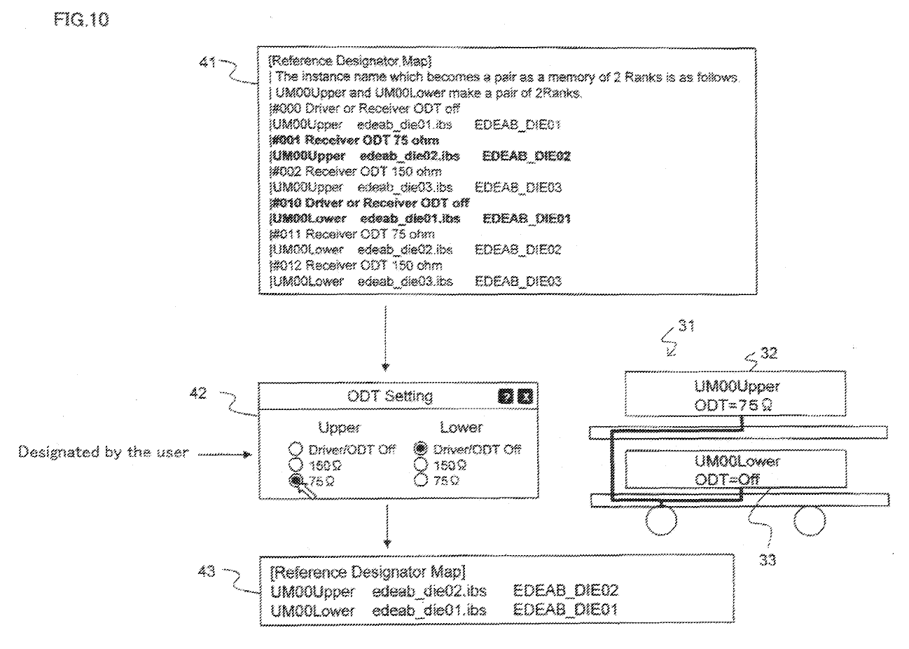

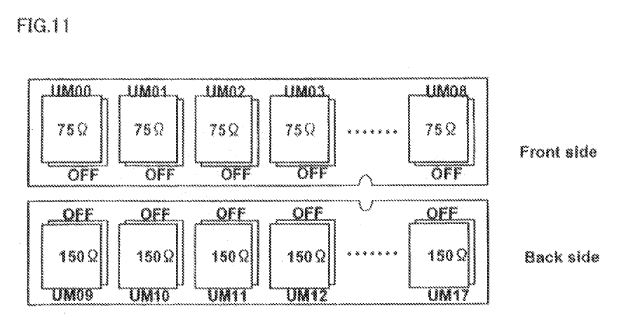

FIG. 10 is a view for explaining the simulation method of the present working example. FIG. 10 shows original IBIS file 41 for setting parameters, combination selection screen 42 that is displayed on display unit 12, and IBIS file 43 after extraction. As shown by original IBIS file 41, the comment symbol “|” and identification codes for identifying choice setting lines are described in lines before the choice setting lines. Lines in which the identification codes are entered together with the comment symbols are referred to as “call lines.”Examples of call lines are shown below:
“|#001 Receiver ODT 75Ω”
“|#010 Driver or Receiver ODT off”

“#001” is the identification code for setting the ODT value of upper chip 32 of UM00 to 75Ω, and “#010” is the identification code for setting the ODT value of lower chip 33 of UM00 to OFF.

When the user enters a command indicating the calling of a file for setting parameters, combination selection screen 42 is displayed on display unit 12. The user manipulates console 14 to designate the combination of ODT settings of upper chip 32 and lower chip 33 of stacked DRAM 31 as shown in FIG. 10. On combination selection screen 42 shown in FIG. 10, 75Ω is designated for the ODT value of upper chip 32, and OFF is designated for the ODT value of lower chip 33. Control unit 13 thus extracts call lines in which the identification code “#001” or “#010” that corresponds with the designated information is appended after the comment symbol at the head of the line in original IBIS fife 41.

Next, when control unit 13 finds each of the call lines that include the identification code “#001” or “#010,” control unit 13 deletes the comment symbols of these choice setting lines to make each of the choice setting lines that follow the call lines effective. Control unit 13 further deletes lines in which other comment symbols are entered, whereby IBIS 43 is produced after extraction.

A dedicated program for extracting desired choice setting lines from the EBD description of the original IBIS file 41 and creating the EDB description shown in IBIS file 43 after extraction is stored in advance in memory unit 11. This dedicated program incorporates a correspondence table of the identification codes and the choices displayed by combination selection screen 42.

When setting ODT of chips in the present working example, the user designates ODT values in the combination screen for each chip, whereupon EBD description is produced in which the desired ODT value setting lines are extracted from the original EBD description. As a result, the user is able to implement a desired simulation without actually knowing the details of the EBD description.

### FOURTH WORKING EXAMPLE

The present working example focuses on the regularity of the ODT values on a DIMM and facilitates the switching control of the ODT values. Chips in which the same ODT values are to be set are grouped, and the desired ODT values are then set in group hatches. Explanation next regards the details of the present working example.

FIG. 11 is a schematic view of an example of settings of ODT values of a DIMM in the present working example. The lower chips of UM00-UM08 on the front side are grouped with the lower chips of UM09-UM17 on the back side. In addition, the upper chips of UM00-UM08 on the front side are in one group, and the upper chips of UM09-UM17 on the back side are in a different group. The same choices are set in group units with the chips grouped in this way.

More specifically, as shown in FIG. 11, the ODT values of the lower chips of UM00-UM08 on the front side and lower chips of UM09-UM17 on the back side are set to the choice “OFF.” The OCT values of the upper chips of UM00-UM08 on the front side are set to choice “75Ω.” The ODT values of the upper chips of UM09-UM17 on the back side are set to “150Ω.” The grouping may be in units of Ranks.

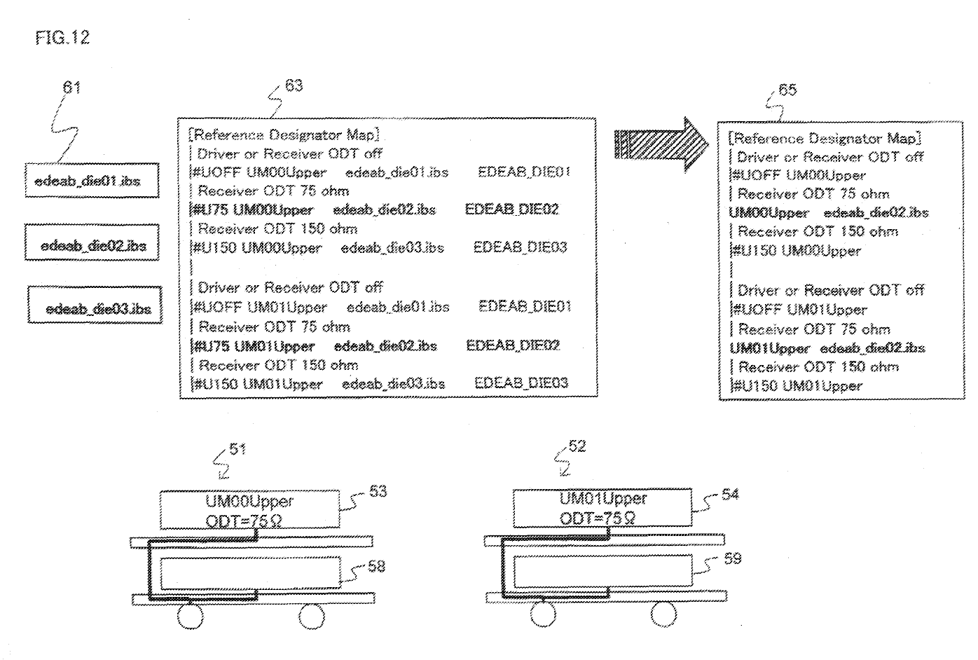

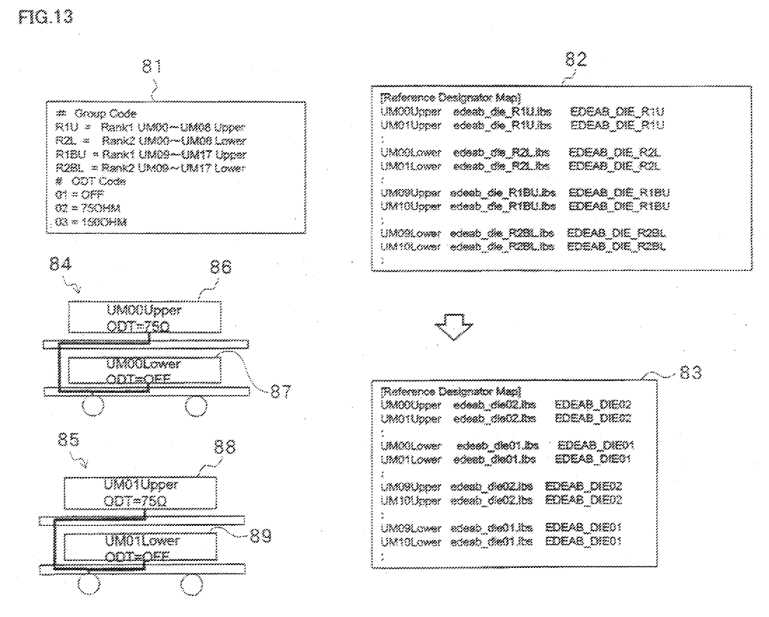

Explanation next regards a simulation method when ODT values are set as shown in FIG. 11. A case is here taken in which the ODT values of the upper chips of UM00-UM08 on the front side are set to the choice “75Ω.” FIG. 12 is a view for explaining the simulation method of the present working example.

The choices of the chips for which the same ODT value is to be set are grouped, and different identification codes are conferred to each group in advance. As shown in FIG. 12, choice file names 61 that differ for each choice of ODT are defined in advance. The definition of each choice file name 61 is the same as in the second working example. Base file 63 that is to serve as the original IBIS file in which all combinations are described is prepared in advance. This base file 63 is a file in the IBIS description file in which common comment symbol-appended identification codes are described at the heads of lines for setting lines of choices that are the same within a group. As explained in FIG. 11, upper chip 53 of stacked DRAM 51 of UM00 and upper chip 54 of stacked DRAM 52 of UM01 are a group in which the same ODT value is set. The comment symbol-appended identification codes for the ODT settings of the front-side upper chips of UM00-UM08 are as follows:
ODT value OFF setting: “|#UOFF”
ODT value 75Ω setting: “|#U75”
ODT value 150Ω setting: “|#U150”

The “#. . . ” that follows comment symbol “|” is the identification code that differs for each choice for front-side upper chips of UM00-UM08.

In a case in which the ODT values of front-side upper chips of UM00-UM08 are to be set to 75Ω for base file 63 shown in FIG. 12, setting file 65 is produced in which the choice setting lines for setting the ODT of front-side upper chips of UM00-UM08 are set to 75Ω is effective when “|#U75” is deleted by a text editor.

Although not shown in FIG. 12, the “U” of the identification codes of upper chips 53 and 54 is set to “L” in the choice setting lines of lower chips 58 and 59 in base file 63, and comment-appended identification codes are entered in advance similar to the upper chips. In this case, choosing 75Ω as the ODT value of upper chips 53 and 54 and OFF as the ODT value of lower chips 58 and 59 necessitates only the replacement “|#U75”→“”and “|#LOFF”→“”. In this way, the choices of parameters can be easily set in batches by means of the replacement function belonging to a typical text editor.

Base file 63 and setting file 65 are thus realized by extracting a portion of the entire description.

in the present working example, the choices for chips that are to have the same ODT settings are grouped by comment symbol-appended identification codes at the heads of choice setting lines, and as a result, the ODT values of chips can be easily set in group units by using the replacement function of a text editor to delete the comment symbol-appended identification codes of the necessary choices, whereby this work can be conducted efficiently.

### FIFTH WORKING EXAMPLE

In the fourth working example, the number of choice setting lines provided in chip units was me number of choices. In the present working example, only one choice setting line is provided for each chip, and the choice file name in this choice setting line is replaced by a desired choice file name. The following explanation regards the simulation method of the present working example. A case is here taken in which chips in which parameters are to be set to the same choice are placed in a single group and the desired choices then set in batches in group units.

Common identification codes are determined in advance for groups of chip that are to have the same parameter settings. EBD description is prepared in which choice file names and component names that includes the above-described identification codes in the choice setting lines of each chip in the “Reference Designator Map” entry of the base file. In addition, a table is prepared in advance of component names and choice file names as described in the second working example. Then, when setting the choices for parameters, the above-described Identification codes are replaced by codes that correspond to the desired ODT settings.

FIG. 13 is a view for explaining the simulation method of the present working example. FIG. 13 gives a schematic representation of an example of the configuration of a DIMM in which 2-Rank stacked chips are mounted. In this case, the upper chips of front-side (UM00-08) and back-side (UM09-17) chips belong to Rank 1, while the lower chips of front-side and back-side chips belong to Rank 2. The front-side chips and hack-side chips of Rank 1 are grouped separately, and the front-side chips and back-side chips of Rank 2 are also grouped separately, resulting in a total of four groups. Common Identification codes in group units are shown below:
“_R1U”: (corresponding to front-side upper chips of the DIMM in Rank 1)
“_R1BU”: (corresponding to back-side upper chips of the DIMM in Rank 1)
“_R2L”: (corresponding to front-side lower chips of the DIMM in Rank 2)
“_R2BL”: (corresponding to back-side lower chips of the DIMM in Rank 2)

These identification codes are defined in code table 81.

The user uses a text editor to rewrite the EBD description, which is described by identification codes in the choice file name and component name of the choice setting lines in base file 82, to any of “01”, “02”, and “03”. “01” corresponds to ODT=OFF, “02” corresponds to ODT=75Ω, and “03” corresponds to ODT-160Ω. The user rewrites each of “_R1U” and “_R1BU” to “02”, and rewrites each of “_R2L” and “_R2BL” to “01” by using a text editor. By means of this rewriting, the ODT values of each chip are set and setting file 83 shown in FIG. 13 is produced.

By means of the above-described settings, the ODT values of each of upper chip 86 and lower chip 87 of UM00 of stacked DRAM 84 shown in FIG. 13 are set to 75Ω and OFF, respectively. In addition, the ODT values of upper chip 88 and lower chip 89 of UM01 of stacked DRAM 85 are set to 75Ω and OFF, respectively.

In the present working example, the choice setting lines that correspond to the number of all choices for each chip need not be prepared in advance in the “Reference Designator Map” entry, and the amount of description of files can therefore be reduced to decrease the file volume.

### SIXTH WORKING EXAMPLE

This working example is a case in which driver strength values can be set as parameters in place of the ODT values, as in the second to fifth working examples. Four choices exist for driver strength: full power, one-half of full power, one-quarter of full power, and one-eighth of full power. The setting of driver strength can be carried out similarly to the above-described example of setting ODT values, and a detailed explanation can therefore be omitted here. In addition, the number of choices is not limited to the four described above.

### SEVENTH WORKING EXAMPLE

This working example is a case in which each of the second to sixth working examples is applied to the simulation method of the stacked package explained in the first working example. In the simulation method of the present working example, each of the second to sixth working examples may be carried out in the first working example, and a detailed explanation is therefore here omitted.

In the present working example, the ODT values and driver strength values can be easily set to correspond to desired model for a memory chip of a stacked PKG, and a stacked PKG can be simulated with high accuracy.

### EIGHTH WORKING EXAMPLE

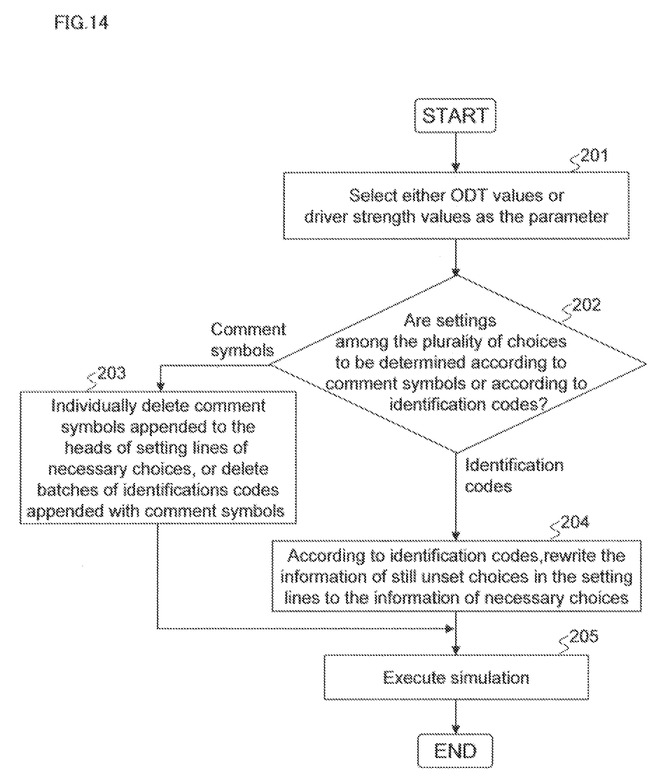

Explanation next regards an ODT value and driver strength simulation method in which the second to sixth working examples are applied. FIG. 14 is a flow chart showing the procedure of the simulation method.

Either ODT values or driver strength values are selected as parameters (Step 201). If is determined whether the necessary choices from among a plurality of choices are to be set by means of the comment symbols, or by means of the identification codes (Step 202).

When the choices are to be set by means of comment symbols, the comment symbols appended to the heads of the necessary choice setting lines are individually deleted, or are deleted in batches by comment symbol-appended identification codes (Step 203). The choice setting lines become effective through the deletion of the comment symbols or the comment symbol-appended identification codes (refer to the second working example and the fourth working example).

Alternatively, if it is determined in Step 202 that settings are to be made by identification codes, the identification codes in choice setting lines are rewritten to choice file names and component names (Step 204). In this way, the information of yet undetermined choices in choice setting lines is rewritten to information of the necessary choices (refer to the fifth working example). The simulation is then executed (Step 205).

Further, classification of identification codes in rank units as described in the fourth working example may also be carried out in this working example. Screens for setting choices may also be displayed as described in the third working example. Finally, the present working example may also be applied in the first working example.

In the present working example, a user can easily execute a simulation for a DIMM in which is mounted a stacked PKG having the ODT function or driver strength function, or DRAM having the ODT function and driver strength function by manipulating information processor 10 and setting parameters and choices in order as described in the foregoing explanation in accordance with a desired model.

In the simulation method of the present invention, paths between one external terminal and a plurality of chips in an IBIS model of stacked chips can be modeled in a form that more closely approximates reality. In addition, parameters such as the resistance value of ODT or the driver strength for each of upper and lower chips can be easily set in an IBIS model of, for example, a memory module.

Finally, the simulation method of the present invention may be applied to a program for realizing execution by a computer, and this program may be recorded on a recording medium that can be read by a computer.

While preferred embodiments of the present invention have been described using specific terms, such description is for illustrative purposes only, and it is to be understood that changes and variations may be made without departing from the spirit or scope of the following claims.

What is claimed is:

1. A simulation method for performing, on an information processor, simulation of an IBIS description relating to input/output characteristics of a memory module that includes a plurality of chips, said simulation method comprising:
a parameter selection step for selecting one from a plurality of parameters relating to said input/output characteristics;
a setting method determination step for, regarding setting lines provided in a file for setting necessary choices from among a plurality of choices for a selected parameter, determining whether to set the choices by means of comment symbols described at beads of lines for causing non-execution of the lines, or to set the choices by means of identification codes, which are identifiers common to chips that are to be set to a same choice;
a choice setting step for, when choices are to be set by means of said comment symbols in said setting method determination step, deleting the comment symbols of the setting lines of said necessary choices among said plurality of choices to make these setting lines effective; and when choices are to be set by means of said identification codes in said setting method determination step, rewriting the identification codes contained in said setting lines to information for setting said necessary choices; and
a step for executing simulation after said choice setting step.

2. A simulation method for performing, on an information processor, simulation of an IBIS description relating to input/output characteristics of a stacked package in which a plurality of chips are stacked, said simulation method comprising:
a modeling step of modeling wiring that is connected from a terminal for connecting to the outside to each chip of said plurality of chips by EBD: and
a step of executing simulation after said modeling step.

3. A simulation method according to claim 2, comprising:
a parameter selection step for, after said modeling step, selecting one from a plurality of parameters relating to said input/output characteristics;
a setting method determination step for, regarding setting lines provided in a file for setting necessary choices from among a plurality of choices for a selected parameter, determining whether to set the choices by means of comment symbols described at the heads of lines for causing non-execution of these line, or to set the choices by means of identification codes, which are identifiers common to chips that are to be set to a same choice;
a choice setting step for, when choices are to be set by means of said comment symbols in said setting method determination step, deleting the comment symbols of the setting lines of said necessary choices among said plurality of choices to make these setting lines effective; and when choices are to be set by means of said identification codes in said setting method determination step, rewriting the identification codes contained in said setting lines to information for setting said necessary choices;
a step for executing a simulation after said choice setting step.

4. A simulation method according to claim 1, wherein:
a comment symbol-appended common code, in which said common code is appended to said comment symbol, is provided in said setting line in which said comment symbol is described at the head of the line; and
when choices are to be set by means of said comment symbols in said setting method determination step, said comment symbol-appended common codes of said setting lines of said necessary choices among said plurality of choices are deleted in a batch to make those setting lines effective.

5. A simulation method according to claim 3, wherein:
a comment symbol-appended common code, in which said common code is appended to said comment symbol, is provided in said setting line in which said comment symbol is described at the head of the line; and
when choices are to be set by means of said comment symbols in said setting method determination step, said comment symbol-appended common codes of said setting lines of said necessary choices among said plurality of choices are deleted in a batch to make those setting lines effective.

6. A simulation method according to claim 1, wherein:
said plurality of chips are grouped in Ranks, which are units of chips that, when accessing the outside, are accessed all at once; and
said identification codes differ for each Rank.

7. A simulation method according to claim 3, wherein:
said plurality of chips are grouped in Ranks, which are units of chips that, when accessing the outside, are accessed all at once; and
said identification codes differ for each Rank.

8. A simulation method according to claim 4, wherein:
said plurality of chips are grouped in Ranks, which are units of chips that, when accessing the outside, are accessed all at once; and
said identification codec differ for each Rank.

9. A simulation method according to claim 1, further comprising:
a step of, after said parameter selection step and before said setting method determination step, displaying said plurality of choices on a screen and setting said necessary choices in accordance with input.

10. A simulation method according to claims 3, further comprising:
a step of, after said parameter selection step and before said setting method determination step, displaying said plurality of choices on a screen and setting said necessary choices in accordance with input.

11. A simulation method according to claim 4, further comprising:
a step of, after said parameter selection step and before said setting method determination step, displaying said plurality of choices on a screen and setting said necessary choices in accordance with input.

12. A simulation method according to claim 5, further comprising:
a step of, after said parameter selection step and before said setting method determination step, displaying said plurality of choices on a screen and setting said necessary choices in accordance with input.

13. A simulation method according to claim 1, wherein said plurality of parameters includes the ODT resistance value or the driver strength value.

14. A simulation method according to claim 3, wherein said plurality of parameters includes the ODT resistance value or the driver strength value.

15. A simulation method according to claim 4, wherein said plurality of parameters includes the ODT resistance value or the driver strength value.

16. A simulation method according to claim 5, wherein said plurality of parameters includes the ODT resistance value or the driver strength value.

17. A simulation method according to claim 6, wherein said plurality of parameters includes the ODT resistance value or the driver strength value.

18. A recording medium in which a program is recorded that, can be read by a computer that executes simulation of IBIS description relating to input/output characteristics of a memory module, said program causing said computer to execute processing that includes the steps of:
upon input of instructions to select one from a plurality of parameters relating to said input/output characteristics, determining a parameter by means of the instructions:
regarding setting lines provided in a file for setting necessary choices from among the plurality of choices of a determined parameter, when instructions are received as input that indicate the setting of choices by means of comment symbols described at heads of lines for causing the non-execution of the lines, and instructions are received as input for deleting the comment symbols of setting lines of said necessary choices among said plurality of choices, deleting the comment symbols of the setting lines to make those lines effective; or, when instructions are received as input indicating the setting of choices by means of identification codes, which are identifiers common to chips that are to be set to a same choice, and information is received as input for selling the identification codes contained in said setting lines to said necessary choices, rewriting the identification codes contained in the setting lines to information for setting the necessary choices; and
after said necessary choices have been set and upon receiving instructions indicating that simulation is to be executed, executing the simulation.

19. A recording medium in which a program is recorded that can be read by a computer that executes simulation of IBIS description relating to input/output characteristics of a stacked package in which a plurality of chips are stacked, said program causing said computer to execute processing that includes the steps of:
upon receiving description by EBD regarding wiring from a terminal for connection to the outside to each chip of said plurality of chips, modeling said wiring by EBD; and
after modeling said wiring by EBD and upon receiving instructions as input indicating that simulation is to be executed, executing the simulation.
